(19) United States
(12) Patent Application Publication
(10) Pub. No.: US 2013/0169810 A1
(43) Pub. Date: Jul. 4, 2013

(54) SYSTEM AND METHOD OF FRAUD DETECTION

(71) Applicants: Geoffrey Scott Hieronymus, Moscow, ID (US); Horace Kenneth Travato, JR., Crownsville, MD (US)

(72) Inventors: Geoffrey Scott Hieronymus, Moscow, ID (US); Horace Kenneth Travato, JR., Crownsville, MD (US)

(21) Appl. No.: 13/723,497

(22) Filed: Dec. 21, 2012

Related U.S. Application Data
(60) Provisional application No. 61/581,265, filed on Dec. 29, 2011.

(51) Int. Cl. G06Q 20/20; H04N 7/18

(52) U.S. Cl. CPC G06Q 20/206; H04N 7/18
USPC 348/148

(57) ABSTRACT

A system and method of preventing fraud in a retail establishment having a drive through window using a point-of-sale (POS) system, a vehicle sensor and customizable algorithms.

The present application claims the priority of U.S. Provisional Patent Application Ser. No. 61/581,265 filed Dec. 29, 2011, the disclosure of which is hereby incorporated by reference.

The present application is directed to loss prevention at retail establishments. Specifically, the present disclosure is directed to loss prevention at retail establishments that utilize a drive through window.

Theft from retail establishments can take many forms. Shoplifting of merchandise is a common concern. Robberies are another concern, particularly with retail establishments that are open 24 hours. However, one of the most significant forms of theft is employee theft due to the access to the merchandise and cash, and the difficulty in detection.

Employee theft can occur in several ways. Employees may steal merchandise from inventory which results in “shrinkage” of the inventory that would otherwise be available for sale. Employees may also forego collecting all or some of the revenue from an accomplice during a sales transaction thereby transferring the “sold” goods without full payment. Employees may also sell products to unsuspecting customers and then pocket some or all of the money paid by the customer for the sale.

The situation whereby an employee initiates a sale transaction at less than the actual price is generally known as “under-ringing.” The situation whereby an employee does not record the sales transaction at all is known as “missing receipt.”

Attempts to minimize employee thefts include the utilization of comprehensive point-of-sale (POS) systems which generate and store transaction data, including an identification of the food ordered, and the revenue collected. The POS systems may generate transaction logs having date and time stamps to assist in identifying instances where the money collected does not match the items ordered.

In response to the use of comprehensive POS systems, employee theft has gotten more sophisticated. Variations of employee theft can include issuing unauthorized or fictitious “refunds”, or failure to properly record a sales transaction in the POS system.

In addition to comprehensive POS systems, it is common for retailers to utilize loss prevention techniques. These techniques can include the use of inventory tags, video/audio surveillance, or on site loss prevention personnel.

Video surveillance is widely used in the retail industry to monitor activities in the retail establishment, including for theft and security. The majority of surveillance systems acts as a repository of video footage which can then be accessed in the event of an incident of concern is later identified or detected. These prior art systems are used reactively, only after an incident has occurred and are not used proactively to seek out theft prevention and security issues. To minimize storage capacity issues, the video footage is typically maintained for a predetermined period of time and then recorded over. Attempts to improve the use of video surveillance systems have included integrating the point of sale transaction data with the video. However, this has led to even more severe storage capacity issues.

Attempts to integrate the POS systems and video surveillance systems have included manual viewing of video to confirm the transactions captured by the POS systems and to confirm compliance with firm policies. Other attempts have utilized rudimentary filtering of the POS data to assist theft prevention analysts focus their viewing of the videos. However, such attempts are labor intensive, costly and result in a high number of false positives being reported. False positives create a resource drain which lowers the overall efficiency of the theft detection system.

Retail establishments are always looking for ways to improve revenues. In low profit margin businesses, one way to increase revenue is to increase the volume of sales. Fast food restaurants are one such low profit margin business which have utilized drive through windows in order to increase the volume of sales. It is estimated that in some fast food establishments, the drive through window accounts for in excess of 60% of the revenues. However, the use of drive through windows has resulted in the unintended consequence of facilitating employee theft. Attempts to use the typical prior art methods of integrated POS date and video surveillance result in the same deficiencies identified above.

The present disclosure is directed to a theft detection system that is specifically designed for drive through windows. The system may include a video surveillance system, a POS collection module, a vehicle detector, customizable algorithms and an integrated reporting system. The present disclosure automatically integrates the video surveillance system with the POS transaction data and the vehicle sensor to identify potential incidents of theft.

### BRIEF DESCRIPTION OF THE DRAWINGS

FIG. 1 is a simplified block diagram illustrating one embodiment of the present disclosure.

FIG. 2 is a simplified flow diagram illustrating the operation of one embodiment of the present disclosure.

### DETAILED DESCRIPTION

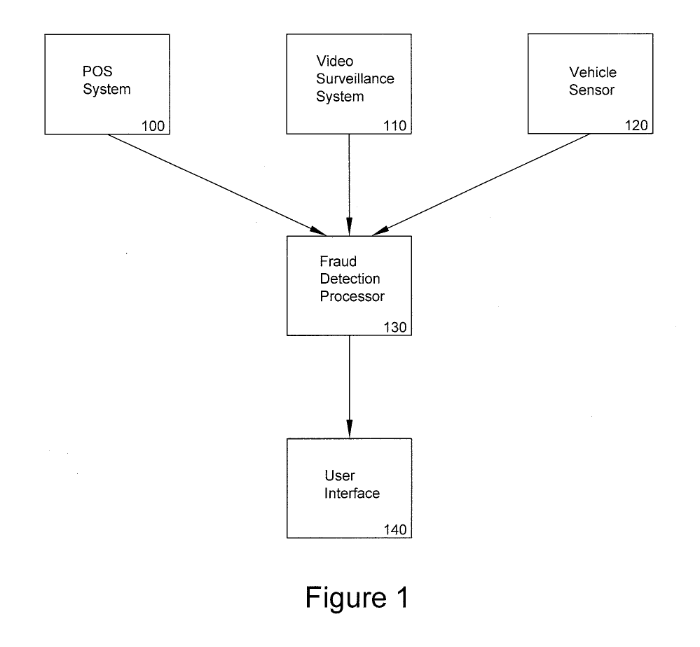

FIG. 1 illustrates the components making up one embodiment of the fraud detection system. POS system 100 generates and stores sales transaction data. The sales transaction data may include the an identification of the products purchased, the prices for the products, payment information including the amount received, credit card information, cash tendered, change given. The sales transaction data will have a time and date associated with it. The POS system 100 will have a database or other storage facility for storing the transaction data. The POS system 100 can be a conventional POS system already implemented by the retail establishment, or can be a POS installed specifically for the fraud prevent techniques of the present disclosure.

The video surveillance system 110 may include several cameras and microphones strategically positioned to record the sales transactions including a view of the cash register, the drive through window and the vehicle at the drive through window, and all audio related to the transaction. The video and audio may include a date and time stamp to allow synchronization with the POS system.

Vehicle sensor 120 detects a vehicle at the drive through window. Any sensor suitable for detecting the presence of a vehicle is suitable. In one embodiment, the sensor may be an existing in-ground magnetic loop sensor that some retail restaurants use to time how long a vehicle is waiting in the drive through lane. In another embodiment, the sensor may be an infrared sensor specifically installed for the theft prevent technology described in the present disclosure. In another embodiment, the sensor could be a video sensor and video analytics could be used to determine timing. Without regard to the type, the sensor may be capable of recording the time the vehicle arrived at the drive through window, and the time that the vehicle departed the drive through window.

POS system 100, video surveillance system 110 and vehicle sensor 120 each provide data to fraud detection processor 130. Fraud detection processor 130 can synchronize the data of each of these inputs using the date time information or other identifying data. Fraud detection processor identifies potential incidents of theft and provides them to a user interface 140 for further analysis and confirmation. The transmitted data can be a transaction data from the POS system, video information from the video surveillance system, vehicle sensor information or any combination of the three.

User interface can be any device capable of receiving data and display video information. It can be a dedicated terminal in the retail establishment or may be a wireless device remotely located. Suitable devices include computers, laptops, personal digital assistants, wireless phones, tablets, monitors and the like.

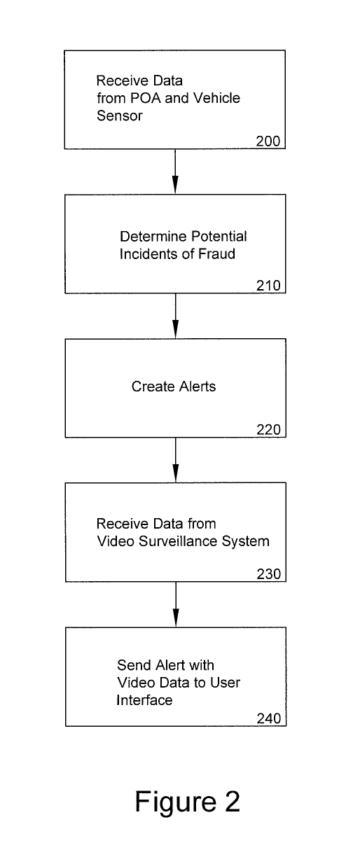

FIG. 2 illustrates a flow diagram for the operation of the embodiment shown in FIG. 1. In step 200, the fraud detection processor receives data from the POS system, and the vehicle sensor. The information can be received in real time, or the information can be retrieved from a storage device from each of the systems.

Data from the vehicle sensor can include the time a vehicle arrived at the customer ordering pedestal, the time the vehicle departed the customer ordering pedestal, the time the vehicle arrived at the drive through window, and the time that the vehicle departed the drive through window.

Data from a point-of-sale (POS) system relating to sales can include a store identification, an employee identification, the date and time of the transaction, product identification codes, product pricing, discounts, refunds, payment information, and other information useful to identify the sales transaction.

In one embodiment, in step 210, the fraud detection processor receives one set of data from the POS system and a second set of data from the vehicle sensor and correlates the two sets of data using the date and time information associated with each data set. The fraud detection processor can then identify an incidence of potential fraud when the vehicle sensor shows that a vehicle was present at the drive through window, but the POS data shows that no sales transaction occurred. This incidence of potential fraud may corresponded to “missing receipt” theft described previously.

In step 220, the fraud detection processor can create an alert identifying incidents of potential fraud and indicating the date and time of potential fraud. These alerts can be transmitted by the fraud detection processor to a user interface for review.

In one embodiment, in step 230, the fraud detection processor can receive a third data set from a video surveillance system. The data can include video data, audio data or both, and may have imbedded date and time information as well as camera microphone identifying information. The fraud detection processor can correlate the video surveillance data using the date and time information to each of the alerts. In one embodiment, in step 240, portions of the data corresponding to the date and time associated with the incidence of potential fraud can be accessed using an electronic link that is identified in an email to an end user form the fraud deception processor. The end user can received the alerts and click on the link of the video surveillance data to confirm whether or not a theft actually occurred. Thus, the information presented to an end user is focused and minimizes the amount of video surveillance data that is sent to the end user and therefore minimizes the amount of time and end user has to spend attempting to identify potential fraud.

In another embodiment, the fraud detection processor can be used to evaluate instances of actual fraud and develop metrics which can then be used to more accurately identify incidences of potential fraud. The fraud detection processor can be programmed with rules based on the metrics to further refine what incidents may be identified for potential fraud. For example, the fraud detection processor may determine that for vehicles that spend more than three minutes at the customer ordering pedestal, the average total for the sales transaction is $18.50. In response, the fraud detection processor can be programmed with a rule that an alert is issued for any vehicle that spends more than three minutes at the customer ordering pedestal whose total transaction amount is less than $10.00, as indicative of an “under rung” amount.

In another embodiment, the fraud detection processor can develop metrics for a given store, a time of day, a day of the week, and specific employee shifts. Employee specific metrics could be average sales transactions for a given time of day while a specific employee or group of employees were working. By using employee metrics to identify normal behaviors, rules can be written to identify abnormal behavior that may be indicative of potential fraud. For example, a shift of employees may have a metric that identifies how long the employees take to fulfill orders of a given size. Another metric may be a correlation between how long it takes to fulfill and order and the amount of the sales transaction. Thus, for a given employee shift, for a given time of day, the metric may be orders which take five minutes to complete correlate to an average totals sales transaction of $24.75. The fraud detector processor may be programmed with a rule to issue an alert if the amount of time a vehicle a vehicle waits to receives its order is approximately five minutes where the total sales transaction is less than $15.00.

In another embodiment, the fraud detection processor can be provided with confirmation data that confirms an actual fraudulent incident associated with an alert and includes the amount of the theft. This information can be used by the fraud detection processor to target specific behaviors indicated by the POS data and the vehicle sensor data to more accurately identify an incidence of potential fraud.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, a composition of matter affecting a machine-readable propagated signal, or a combination of one or more of them.

The term “circuitry” encompasses all apparatus, devices, and machines for processing data, including by way of example a programmable processor, a computer, or multiple processors or computers. The circuitry can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed:

1. A method of preventing fraud in a retail establishment having a drive through window, comprising:
receiving first data from a sensor indicating the presence of a vehicle at a drive through window of a retail establishment, wherein the first data includes a date and time indication;
receiving second data from a point-of-sale (POS) system relating to sales information for a sales transaction;
determining an incidence of potential fraud as a function of the first and second data;
creating an alert identifying the determined instance of potential fraud indicating the date and time of potential fraud.

2. The method of claim 1 wherein the second data includes a transaction amount and a date and time indication.

3. The method of claim 2 further comprising the steps of:
receiving third data from a video surveillance system; and
identifying a portion of the third data that corresponds to the date and time of the determined potential incidence of fraud.

4. The method of claim 3 including the step of displaying the identified portion of the third data.

5. The method of claim 1 wherein the step of determining an incidence of potential fraud is based on the presence of a vehicle and the absence of a sales transaction.

6. The method of claim 1 wherein the sensor is an infrared detector.

7. The method of claim 1 wherein the sensor is an in-ground magnetic loop sensor.

8. The method of claim 3 wherein the step of creating an alert includes the step of e-mailing the identified portion of the third data to be displayed.

9. The method of claim 8 wherein the identified portion of the third data is contained in an electronic link in an e-mail.

10. The method of claim 1 wherein the first data indicates the amount of time the vehicle spent at the drive through window.

11. The method of claim 1 wherein the first data indicates the amount of time a vehicle spent at the customer ordering pedestal.

12. A system for preventing fraud in a retail establishment having a drive through window, comprising:
a memory for storing computer readable code; and
a processor operatively coupled to the memory, the processor configured to:
receive first data from a sensor indicating the presence of a vehicle at a drive through window of a retail establishment, wherein the first data includes a date and time indication;
receive second data from a point-of-sale (POS) system relating to sales information for a sales transaction;
determine an incidence of potential fraud as a function of the first and second data; and
create an alert identifying the determined instance of potential fraud indicating the date and time of potential fraud.

13. The system of claim 12 wherein the second data includes a transaction amount and a date and time indication.

14. The system of claim 13 wherein the processor further configured to:
receive third data from a video surveillance system; and
identify a portion of the third data that corresponds to the date and time of the determined potential incidence of fraud.

15. The system of claim 13 wherein the processor further configured to send the alert and the identified portion of the third data to a user interface.

16. A computer program for preventing fraud in a retail establishment having a drive through window, comprising:
a computer usable non-transitory medium having computer readable program code modules embodied in said medium for preventing fraud;
a computer readable first program code module for receiving first data from a sensor indicating the presence of a vehicle at a drive through window of a retail establishment, wherein the first data includes a date and time indication;
a computer readable second program code module for receiving second data from a point-of-sale (POS) system relating to sales information for a sales transaction;
a computer readable third program code module for determining an incidence of potential fraud as a function of the first and second data; and
a computer readable fourth program code module for creating an alert identifying the determined instance of potential fraud indicating the date and time of potential fraud.

17. The computer program of claim 16 wherein the second data includes a transaction amount and a date and time indication.

18. The computer program of claim 17 further comprising:
a computer readable fifth program code module for receiving third data from a video surveillance system; and
a computer readable sixth program code module for identifying a portion of the third data that corresponds to the date and time of the determined potential incidence of fraud.

19. The computer program of claim 18 further comprising a computer readable seventh program code module for sending the alert and the identified portion of the third data to a user interface.

20. The method of claim 3 wherein the third data is audio data.
